(19) United States
(12) Patent Application Publication
(10) Pub. No.: US 2009/0196821 A1
(43) Pub. Date: Aug. 6, 2009

(54) PLATED COBALT-BORON CATALYST ON HIGH SURFACE AREA TEMPLATES FOR HYDROGEN GENERATION FROM SODIUM BOROHYDRIDE

(75) Inventors: Krishnan Palanichamy, Newark, DE (US); Ajay K. Prasad, Newark, DE (US); Suresh G. Advani, Newark, DE (US)

Correspondence Address: RATNERPRESTIA, P.O. BOX 1596, WILMINGTON, DE, 19899, US

(73) Assignee: University of Delaware, Newark, DE (US)

(21) Appl. No.: 12/367,089

(22) Filed: Feb. 6, 2009

Related U.S. Application Data
(60) Provisional application No. 61/063,738, filed on Feb. 6, 2008.

(51) Int. Cl. C01B 3/02; B01J 21/02

(52) U.S. Cl. 423/648.1; 502/207

(57) ABSTRACT

The invention provides a catalyst-coated nickel template including
a) an open-cell nickel foam having within it pores defined by an internal nickel surface, the foam also having an external nickel surface not within the pores; and
b) a layer of catalyst including Co and B on at least a portion of the internal nickel surface and at least a portion of the external nickel surface.

The invention also provides a method of making a catalyst-coated nickel template that includes contacting a nickel template with a solution including a cobalt salt, a complexing agent, and a boron source selected from organoboranes and organoamine boranes under conditions sufficient to deposit boron and cobalt on a surface of the nickel template.

Methods of generating H₂ at a predetermined rate include contacting a NaBH₄ solution with the catalyst-coated nickel template.

### CROSS REFERENCE TO RELATED APPLICATIONS

This application claims priority benefit of U.S. Provisional Application No. 61/063,738, filed Feb. 6, 2008, the entirety of which is incorporated herein by reference.

### STATEMENT REGARDING FEDERALLY SPONSORED RESEARCH

The U.S. Government has a paid-up license in this invention and the right in limited circumstances to require the patent owner to license others on reasonable terms as provided for by the terms of Contract No. JPP-05-DE-03-7001, awarded by the Federal Transit Administration.

### BACKGROUND OF THE INVENTION

Hydrogen is a fuel with significant potential for use as an energy source in a variety of commercial applications. For example, hydrogen-fueled Polymer Electrolyte Membrane Fuel Cells (PEMFCs) are being developed as pollution-free power sources for transportation, residential and portable applications. In a H₂/O₂ PEMFC, chemical energy stored in H₂ is converted into electrical energy in presence of a catalyst (typically Pt/C) and a proton-conducting polymer electrolyte membrane. However, commercialization of PEMFC technology has been difficult due to challenges encountered in establishing the H₂ supply infrastructure. Typically, H₂ is stored in pressurized cylinders due to the low volumetric energy density of gaseous H₂. In addition to safety concerns, high-pressure H₂ tanks have very low gravimetric and volumetric storage efficiencies. Moreover, adequate materials technologies for high-pressure storage are yet to be advanced. On the other hand, chemical hydrides have good gravimetric storage capacity and their alkaline solutions are relatively safe for transportation. Among the chemical hydrides, sodium borohydride (NaBH₄) is desirable due to its high H₂ content of 10.57 wt % and the excellent stability of its alkaline solutions. Aqueous solutions of NaBH₄ undergo hydrolysis in the presence of suitable catalysts to produce H₂, essentially free from impurities. However, many catalysts for such hydrolysis are based on expensive precious metals such as Pt and Ru.

Additionally, catalysts for NaBH₄ hydrolysis have typically been prepared in powder form. The use of powdered catalysts for H₂ generation has inherent disadvantages such as (1) difficult post-reaction separation and recycling of the catalyst from the viscous suspension; (2) tendency of the suspended particles to aggregate, especially at high concentration; and (3) difficult adaptation of particulate suspensions to continuous flow systems. Catalysts in forms that reduce or eliminate any of such concerns would be of significant commercial utility.

### SUMMARY OF THE INVENTION

In one aspect, the invention provides a catalyst-coated nickel template including

a) an open-cell nickel foam having within it pores defined by an internal nickel surface, the foam also having an external nickel surface not within the pores; and

b) a layer of catalyst including Co and B on at least a portion of the internal nickel surface and at least a portion of the external nickel surface.

In another aspect, the invention provides a method of making a catalyst-coated nickel template. The method includes contacting a nickel template with a solution including a cobalt salt, a complexing agent, and a boron source selected from organoboranes and organoamine boranes under conditions sufficient to deposit boron and cobalt on a surface of the nickel template.

In yet another aspect, the invention provides a method of generating H₂ at a predetermined rate. The method includes:

a) providing one or more monolithic catalyst-coated nickel templates, each including a nickel template having on a surface thereof a catalyst coating including at least Co and B;

b) providing a solution of NaBH₄; and

c) causing a portion of the one or more monolithic catalyst-coated nickel templates to contact the NaBH₄ solution to a degree capable of generating the hydrogen at the predetermined rate.

### BRIEF DESCRIPTION OF THE DRAWINGS

FIG. 1a and FIG. 1b show normalized wt. % of boron in the electroless plated samples as a function of dimethyl amineborane (DMB) concentration and plating time, respectively.

FIG. 2(i) and FIG. 2(ii) show X-ray diffraction patterns for a Ni-foam template and an electroless plated CoB/Ni-foam template (at various plating times) respectively.

FIG. 3(a) depicts the Ni-foam template, FIG. 3(b) shows the surface of the electroless plated CoB/Ni-foam template, and FIG. 3(c) shows the cross-section of the electroless plated CoB/Ni-foam template.

FIG. 4(a) shows the effect of electroless plating time on H₂ generation using 5 wt. % NaBH₄ (5 wt. % NaOH), and FIG. 4(b) shows the effect of NaBH₄ concentration on H₂ generation.

FIG. 5(a) shows a repetitive use test, 5 wt. % NaBH₄ (5 wt. % NaOH), and FIG. 5(b) depicts an extended durability test, 10 wt. % NaBH₄ (5 wt. % NaOH).

FIG. 6 shows an SEM image of the surface morphology of the CoB alloy deposit on the surface of an electroplated CoB/Ni-foam template.

FIG. 7(i) and FIG. 7(ii) depict H₂ generation using electroplated CoB/Ni-foam templates: (a) templates prepared at different current densities, 5 wt. % NaBH₄ (5 wt. % NaOH); (b) effect of boric acid (H₃BO₃) concentration, current density of template preparation, 80 mA cm⁻², 5 wt. % NaBH₄ (5 wt. % NaOH).

FIG. 8(a) and FIG. 8(b) show plots of In k against 1/T for H₂ generation by electroless plated and electroplated CoB/Ni-foam templates respectively.

### DETAILED DESCRIPTION OF THE INVENTION

The invention provides Co—B, Ni—B, and Co—Ni—B alloy catalysts in the form of thin films on high surface area templates, and methods for making such catalyst-coated templates. The thin film catalyst-coated templates are highly suitable for hydrogen-on-demand systems for several reasons. First, H₂ generation can be initiated by simply inserting the thin-film catalyst-coated template into the NaBH₄ solution, and the generation rate can be easily controlled by adjusting the contact area between the catalyst-coated template and the NaBH₄ solution. Likewise, H₂ generation can be terminated by simply retracting the catalyst-coated template from the solution. Therefore, fabrication of a H₂ generator can be simplified since a dedicated catalyst separation unit is not required. Additionally, the spent borate solution resulting from borohydride hydrolysis is essentially free of catalyst particles and can therefore be directly taken for regeneration or waste disposal. The catalyst-coated templates of this invention typically exhibit very tight bonding of the catalyst to the template, thus allowing the high surface area catalyst to be used repeatedly with minimal loss of activity.

The template surface to be coated may of any shape, including ones with uneven surfaces or surfaces that are within a curved or porous template such as a foam or a sponge. For example, an open-cell foam or sponge may be used. Other useful shapes include screens, perforated plates, tubular, and cylindrical. Typical suitable templates may have a surface area in a range from about 0.02 to 0.06 m²g⁻¹, and typically in a range from about 0.04 to 0.05 m²g⁻¹, but higher and lower surface area materials can also be used. Catalyst-coated articles according to the invention combine high surface area (and hence high catalytic capacity) with the ease of recovery provided by a single monolithic catalyst article (sheet, rod, disc, strip, etc) of catalyst, as well as the ability to regulate hydrogen production rate to a predetermined level by varying the degree to which the article is immersed in the sodium borohydride solution. Typically, the template to be coated (and also the catalyst-coated template) will be relatively thin, for example at most 4 mm or in some cases at most 2 mm thick, although higher thicknesses may be used. The thickness will typically be at least 0.1 mm or 0.5 mm, but in some embodiments it may be less. A nickel foam template coated with catalyst according to the invention has within it pores defined by an internal nickel surface, and also has an external nickel surface not within the pores. The catalyst comprising Co and B is present on at least a portion of the internal nickel surface as well as on at least a portion of the external nickel surface.

### EXAMPLES

### Materials

Nickel foam (INCOFOAM™) from Inco special products was used as the template for coating the CoB alloy catalyst. The foam had a surface area ˜0.04-0.05 m²g⁻¹. Boric acid (H₃BO₃, 99.0 wt. %), cobalt (II) chloride hexahydrate (COCl₂.6H₂O, 99.0 wt. %), cobalt (II) sulfate heptahydrate CoSO₄.7H₂O, 99.0 wt. %, dimethylamine borane (CH₃)₂NHBH₃, DMB 99.0 wt. %), sodium succinate (Na₂C₄H₄O₄.6H₂O, 99.0 wt. %) from Across Organics, acetone (CH₃COCH₃, 99.5 wt. %), sulfuric acid (H₂SO₄, 99.5 wt. %), sodium hydroxide (NaOH, 99.50 wt. %), sodium tartrate dihydrate (Na₂C₄H₄O₆.2H₂O, 99.0 wt. %) from Fischer Scientific Inc., sodium citrate dihydrate (Na₃C₆H₅O₇.2H₂O) from EMD Chemicals, USA, and sodium borohydride (NaBH₄, 98.5 wt. % VENPURE™) from Rohm and Haas were used in this study. The chemicals were used as received without any further purification.

### Preparation of Thin-Film CoB/Ni-Foam Templates by Electroless Plating

Electroless plating was carried out using cobalt (II) sulfate as the source of Co²⁺, sodium succinate as the complexing agent, and dimethylamine borane as the source of boron as well as the reducing agent. Nickel foam, 0.17 cm thick was cut into 2 cm×2 cm square specimens, washed with acetone followed by de-mineralized (DM) water and dried at 110° C. The specimens were weighed and activated in 10 wt. % H₂SO₄ for 10 min, washed with DM water and transferred to the electroless plating bath. The specimens were mounted inside the plating bath with a clamp. The plating bath was prepared by dissolving the respective bath components in DM water. Bath composition and plating conditions used for plating the Co—B alloy catalyst film onto Ni-foam templates are listed in Table 1. Three complexing agents, namely sodium succinate, sodium citrate, and sodium tartrate were used to maintain the Co²⁺ in complex form. Stability of the bath was poor when sodium tartrate was used as the complexing agent. Stability as well as throwing power were good with sodium succinate and hence it was used as the complexing agent for the plating procedures detailed herein. The pH of the bath was maintained between 4 and 5 by adding either 1.0 M NaOH or 1.0 M H₂SO₄ solution.

TABLE 1
Bath composition and plating conditions for electroless plating of
CoB thin-film alloy on Ni-foam templates

| | |
|---|---|
| CoSO₄•7H₂O (M) | 0.10 |
| Na₂C₄H₄O₄•6H₂O^{a} (M) | 0.10 |
| (CH₃)₂NHBH₃ (M) | 0.10 |
| Bath pH | 4-5 |
| Bath temperature (° C.) | 60 |
| Plating time (h) | 1-4 |

^{a}0.1 M Na₃C₆H₅O₇•2H₂O or Na₂C₄H₄O₆•2H₂O may be used instead

In this embodiment, a concentration of 0.100 M for each of cobalt (II) sulfate heptahydrate CoSO₄.7H₂O, sodium succinate (Na₂C₄H₄O₄) and dimethylamine borane (CH₃)₂NHBH₃ was found particularly suitable for the preparation of the catalyst-coated templates by electroless plating at 60° C. with a pH value of 4-5 and a plating time of 1 h. Instead of succinic acid, other complexing agents such as maleic acid may be used. Sodium or potassium salts of the complexing agents may be used. Also, dimethylamine borane may be replaced with another boron source such as an organoborane (e.g., diethyl borane) or a different organoamine borane such as ethylenediamine borane or phenethylamine borane.

### Preparation of Thin-Film CoB/Ni-Foam Templates by Electroplating

Electroplating was carried out using cobalt (II) sulfate and cobalt (II) chloride as the sources of cobalt, and boric acid as the source of boron. For the electroplating process, a stainless steel specimen of same dimensions as the Ni-foam template was used as the anode. DC current was supplied from a regulated power supply and an ammeter was connected in series to monitor the current. After plating, the specimens were removed from the bath, washed to remove the adhering solution, and weighed to determine the quantity of the plated CoB alloy. The composition of the catalyst-coated templates was determined by inductively coupled plasma (ICP) analysis. Electroplating bath composition and plating conditions are given in Table 2.

TABLE 2
Bath composition and plating conditions for electroplating of CoB
thin-film alloy on Ni-foam templates

| | |
|---|---|
| CoSO₄•7H₂O (M) | 0.100-0.500 |
| CoCl₂•6H₂O (M) | 0.100-0.500 |
| H₃BO₃ (M) | 0.100-1.000 |
| Current Density (mAcm⁻²) | 80-320 |
| pH | 4-5 |
| Temperature (° C.) | 60 |

Concentrations of 0.125 M for each of cobalt (II) chloride hexahydrate (CoCl₂.6H₂O), CoSO₄.7H₂O, 0.125 M of boric acid at the current density range of 160-320 mA cm⁻² and a temperature of 60° C. was identified as the optimum condition for the electroplating method under the specific conditions tested here.

### Characterization of the Catalysts by X-Ray Diffraction Measurement

X-ray powder diffraction patterns were obtained at room temperature on a Rigaku MiniFlex powder diffractometer using Ni filtered Cu Ka radiation. All of the runs included θ-θ scans (2θₘₐₓ=90°) with intervals of 0.05° and a 1 s counting time. The data analysis was carried out using the JADE 6.5 software package.

### Scanning Electron Microscopy

The surface morphology as well as cross-sections of the Ni-foam template, and the catalyst-coated templates were examined by scanning electron microscope (SEM), JSM-7400 from JOEL Ltd., Japan. For the surface morphology, a small section of the template was cut and fixed on to the SEM sample holder using double-sided tape. For the cross-sectional examination, a fresh cross-section was cut using sharp scissors and examined; a thin layer of Au—Pd was sputtered before examination.

### H₂ Generation Experiments

In a typical H₂ generation experiment, 25 mL of NaBH₄ solution was placed in a thermostated tubular glass vessel maintained at 25° C. The template was immersed in the solution using a clamp. The generated H₂ was measured using a mass flow meter whose output was continuously recorded by a computer. Suitability of the catalyst-coated templates for extended operation was studied in a 1000 mL capacity tubular reactor. About 700 mL of 10 wt. % NaBH₄ (5 wt. % NaOH) solution was placed in the reactor and the experiment was continued until all the NaBH₄ in the solution was hydrolyzed.

### Activation Energy Calculation

The experimental set-up was the same as described above for H₂ generation. A small piece of the catalyst-coated template was cut and weighed to determine the weight of CoB catalyst present in the template. Then, the template was immersed in the NaBH₄ solution using a clamp. The H₂ generation vessel was assembled inside the water bath; temperature of the water bath was continuously increased. The rate of H₂ generation as well as temperature inside the vessel was continuously recorded. The rate of hydrogen generation at different temperatures was used to calculate the rate constant and plotted against 1/T to obtain the activation energy as described further below.

### Electroless Plating Results

The catalyst-coated templates were dissolved in nitric acid (HNO₃) and analyzed by ICP to determine the weight percentages (wt. %) of Ni, Co and B. Typical compositions of the templates after different plating times are given in Table 3. The wt. % of Co and B increased with plating time. However, the wt. % of B is less than that required for stoichiometric CoB compounds like CoB, CO₂B or CO₃B. The low wt. % of B in the deposits indicates that the Co metal is simultaneously getting deposited along with CoB alloy.

TABLE 3
Composition of electroless plated CoB/Ni-foam templates

| Plating | Composition (wt. %) | | |
|---|---|---|---|
| Time | Ni | Co | B |
| 1 h | 41.63 | 57.75 | 0.61 |
| 2 h | 37.22 | 61.99 | 0.77 |
| 4 h | 33.93 | 65.21 | 0.85 |

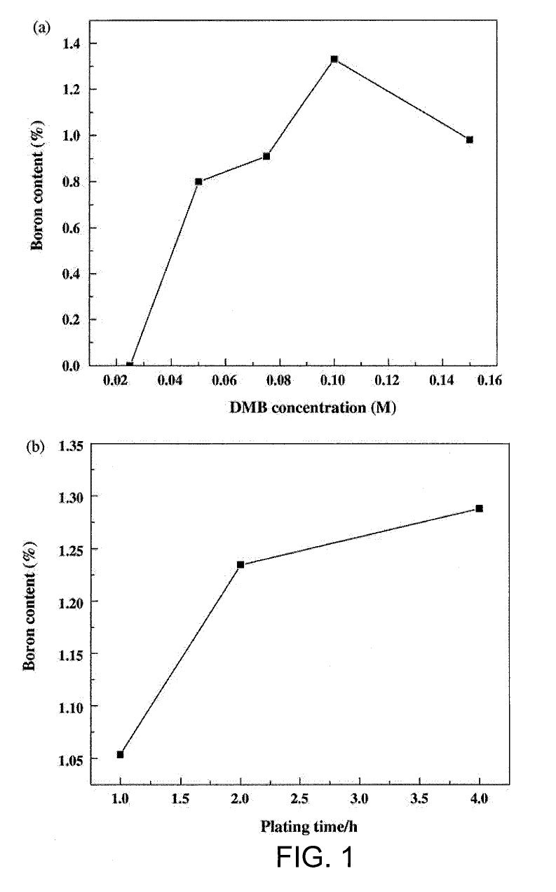

Normalized wt. % of B in the deposited CoB alloy for various concentrations of DMB as well as plating time are plotted in FIG. 1a and FIG. 1b, respectively. The normalized B content was in the range of about 1.0-1.3. The B content in the deposit increased with DMB concentration and reached a maximum value of 1.33% for 0.100 M concentration of DMB in the bath. The B content decreased with further increase in DMB concentration; this could be due to increased rate of Co metal deposition.

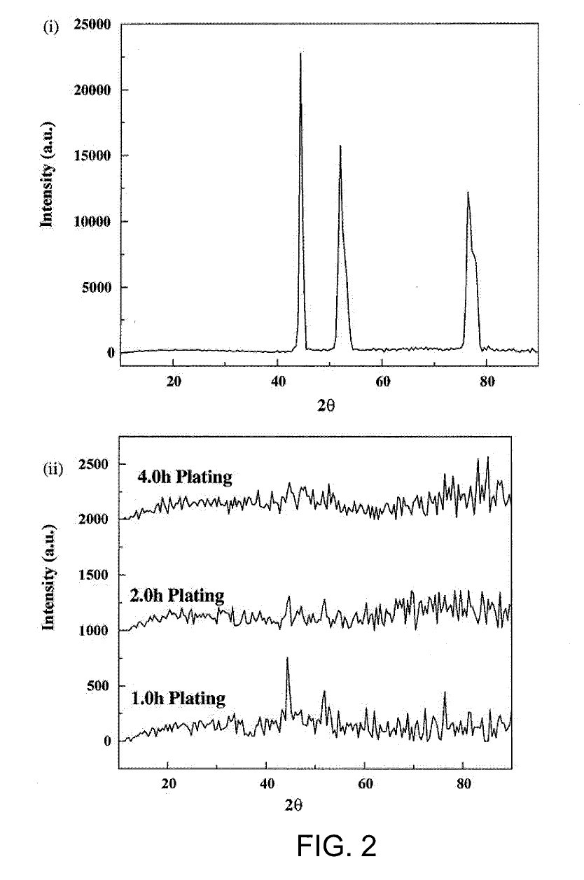

FIG. 2(i) and FIG. 2(ii) show X-ray diffraction patterns for a Ni-foam template and an electroless plated CoB/Ni-foam template (at various plating times) respectively. The Ni-foam template shows three characteristic diffraction peaks for nickel (2θ=44.5° (1 1 1), 51.8° (2 0 0) and 76.4° (2 2 0)) indicating the face centered cubic phase of nickel. However, the diffraction peaks of Ni are masked in the catalyst-coated templates. The diffraction peaks of Ni are weak in the 1 h plated sample and almost absent in the 4 h plated sample. Absence of diffraction peaks indicates the amorphous nature of the coating; CoB is amorphous and does not show strong peaks in X-ray diffraction. Since the coating obtained in the present study is a mixture of CoB and Co, the absence of diffraction peaks indicates that the deposited Co is also amorphous in nature.

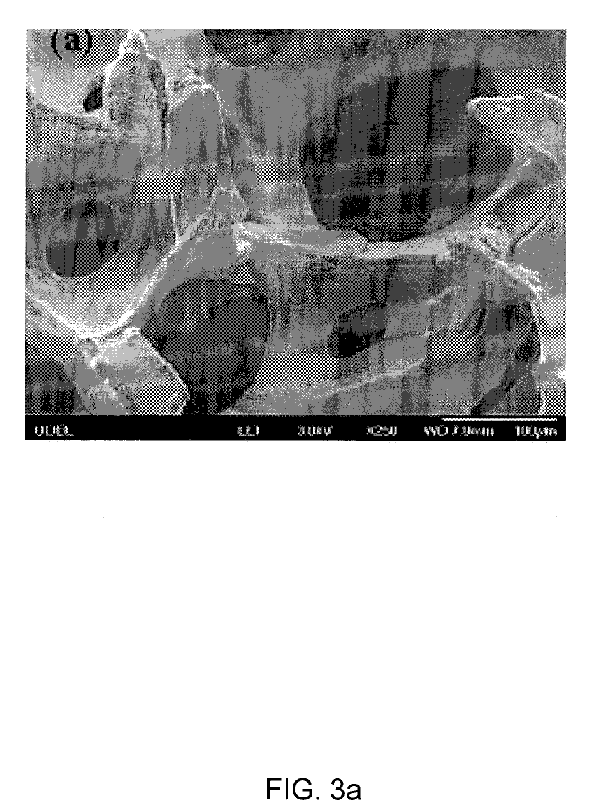

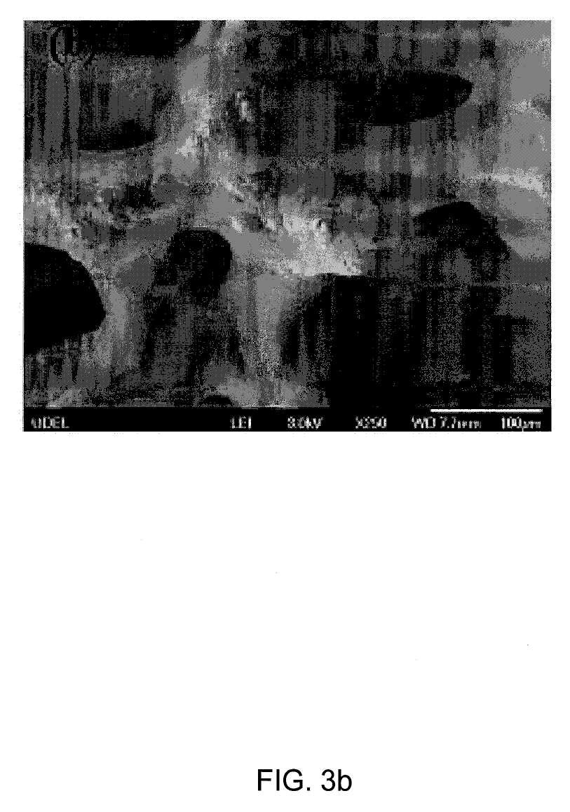

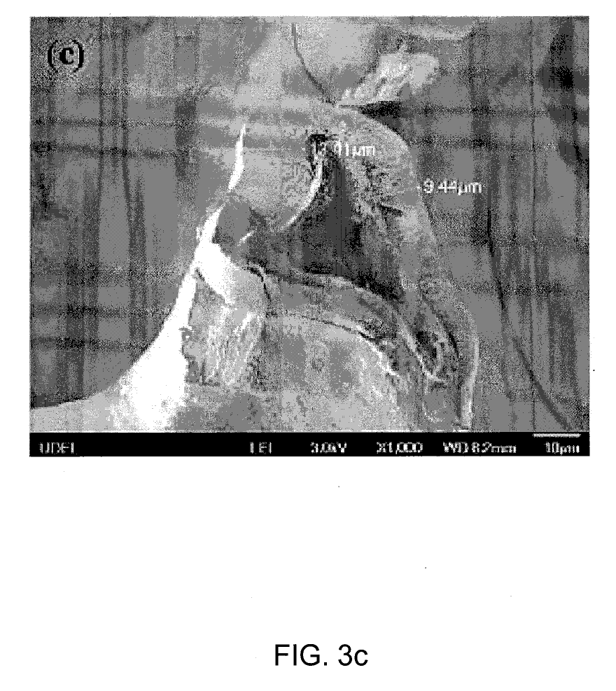

SEM micrographs of the surface of the Ni-foam template, and the surface as well as the cross-section of electroless plated templates, are shown in FIGS. 3(a)-3(c). FIG. 3(a) depicts the Ni-foam template, FIG. 3(b) shows the surface of the electroless plated CoB/Ni-foam template, and FIG. 3(c) shows the cross-section of the electroless plated CoB/Ni-foam template.

The SEM micrographs reveal excellent adherence of the catalyst coating on the Ni-foam template, which is highly desirable for the extended usage of these templates for H₂ generation. The cross-sectional view also confirms the intimate adherence as well as dense morphology of the coating. The thickness of the coating is around 10-15 μm, which is higher than the wall thickness of the hollow foam template.

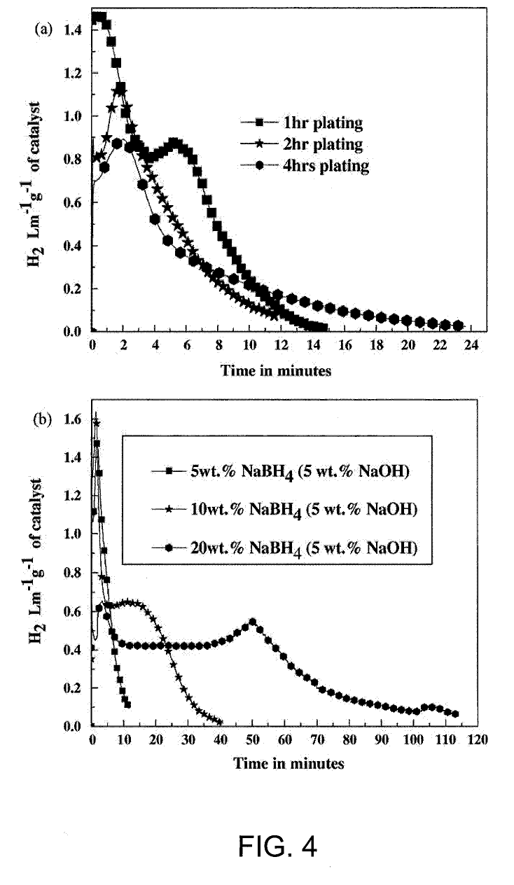

H₂ generation rates obtained using three electroless plated CoB/Ni-foam templates with plating times of 1, 2 and 4 h, as well as the effect of NaBH₄ concentration on the rate of H₂ generation, are presented in FIG. 4(a) and FIG. 4(b). FIG. 4(a) shows the effect of electroless plating time using 5 wt. % NaBH₄ (5 wt. % NaOH), and FIG. 4(b) shows the effect of NaBH₄ concentration. The maximum H₂ generation rate of 1.46 L min⁻¹g⁻¹ of the catalyst was obtained with the 1 h plated template. The maximum H₂ generation rate reduced with increased plating time and a maximum of 0.90 L min⁻¹g⁻¹ was obtained with the 4 h plated template. The Ni-foam template has a cell size of 400-850 μm, so with an increase in plating time the thickness of the coating increases to such an extent that both the cell size as well as the active catalyst area are reduced. Both of these would reduce the rate of H₂ generation; reduction in cell size will impede mass transfer and increase in plating thickness will reduce the active catalyst area.

Since NaBH₄ based hydrogen generators are being developed for portable fuel cells, the use of highly concentrated NaBH₄ solution as the fuel will help to reduce the overall weight of the fuel cell power pack. However, the stability of NaBH₄ solution towards hydrolysis increases with NaBH₄ concentration due to higher alkalinity of the concentrated solution. Hence, it is useful to evaluate the effect of NaBH₄ concentration on the performance of the catalyst. Therefore, the performance of the electroless plated catalyst-coated templates was evaluated in NaBH₄ solutions, varying in concentration from 5 to 30 wt. % and the results are shown in FIG. 4(b).

The H₂ generation rate was highest (1.6 L min⁻¹g⁻¹) with 5 wt. % NaBH₄ solution. The rate decreased on increasing the NaBH₄ concentration. A H₂ generation rate of around 0.5 L min⁻¹g⁻¹ was obtained with 20 wt. % NaBH₄ solution. At NaBH₄ concentrations beyond 25 wt. %, the solution becomes highly viscous due to the solidification of hydrolyzed metaborate. The generation of H₂ gas in the highly viscous solution leads to disintegration of the Ni-foam template. However, disintegration of the Ni-foam template could be avoided by periodic addition of water to the H₂ generator if concentrated NaBH₄ solutions (>25 wt. %) are used for H₂ generation.

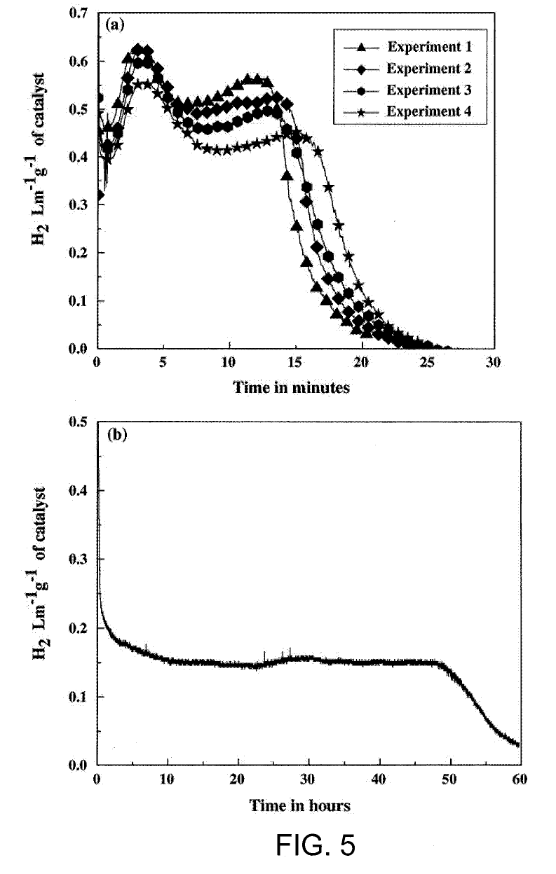

FIG. 5(a) and FIG. 5(b) show H₂ generation using an electroless plated CoB/Ni-foam template. FIG. 5(a) shows a repetitive use test, 5 wt. % NaBH₄ (5 wt. % NaOH), and FIG. 5(b) depicts an extended durability test, 10 wt. % NaBH₄ (5 wt. % NaOH).

H₂ generation profiles are plotted in FIG. 4 and FIG. 5. Once the catalyst-coated Ni-foam template is immersed in NaBH₄ solution, H₂ generation commences immediately, the rate increases rapidly and reaches a maximum value, and then starts to decline and eventually reaches a more or less steady value (FIG. 5(a)).

The thin-film catalyst-coated templates of this invention are suitable for repetitive use. Once all the NaBH₄ is hydrolyzed, the spent metaborate could be drained and new NaBH₄ solution added to resume H₂ generation, or the template could be removed and re-used. To evaluate the potential for such re-use, the same template was used in four subsequent experiments and the H₂ generation profiles are shown in FIG. 5(a). Although there is a gradual reduction of catalytic activity, the catalysts maintain their activity for prolonged durations. The template was washed, dried and weighed at the end of the four experiments to evaluate the loss of catalyst from the template. The loss was insignificant, confirming the excellent adherence of the coating to the template. The electroless plated CoB/Ni-foam template was tested in 10 wt. % NaBH₄ (5 wt. % NaOH) for extended durations of up to 60 h and the H₂ generation profile is given in FIG. 5(b). The H₂ generation rate decreased substantially within 5 h; thereafter, the rate remained more or less constant up to 60 h which establishes their suitability for prolonged operation. There was very little weight loss of about 2.0 wt. % after 60 h of testing.

### Electroplating Results

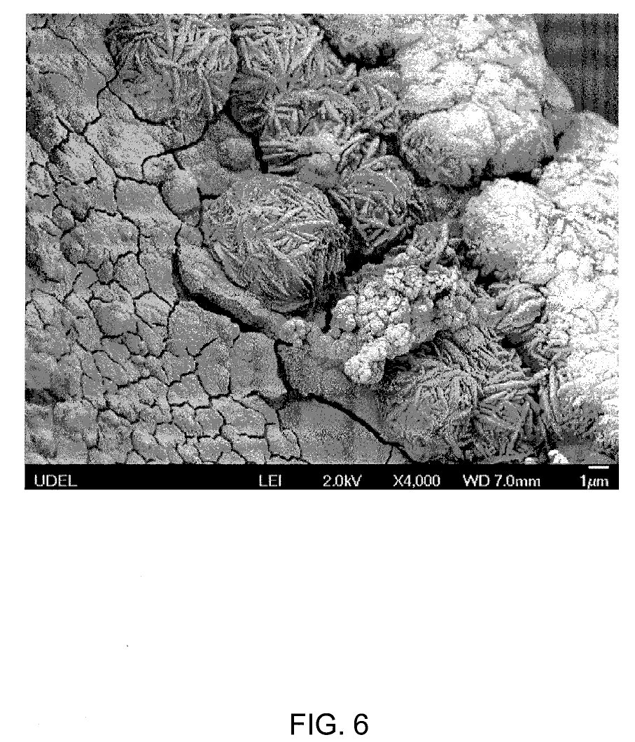

The surface morphology of the CoB alloy deposit on the surface of an electroplated CoB/Ni-foam template is shown in the SEM image of FIG. 6. Two distinct morphologies, i.e. agglomerate and rod forms, can be observed in the deposits. Since the deposit is a mixture of CoB and Co metal, the two different morphologies could be due to the simultaneous presence of CoB and Co metal in the deposit. The B content in the deposits was in the range of 0.20-0.60 wt. %. The B content in the deposit depends on the concentration of H₃BO₃ in the bath; B content increased from 0.20 to 0.60 wt. % when the H₃BO₃ concentration was increased from 0.100 to 0.75M. The bath was not stable at higher concentrations due to the precipitation of H₃BO₃. Since a stainless steel strip was used as anode, the electroplated alloy deposits also contained about 5-10 wt. % of iron.

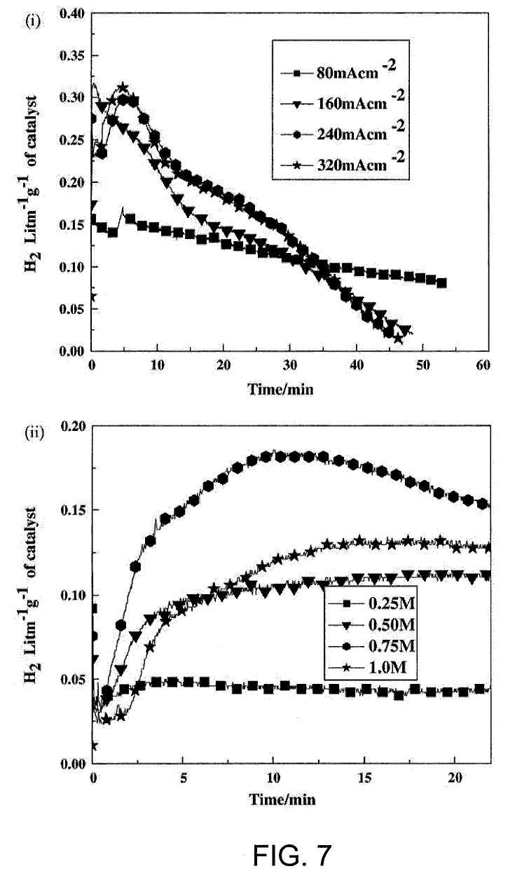

FIG. 7(i) and FIG. 7(ii) depict H₂ generation using electroplated CoB/Ni-foam templates: (a) templates prepared at different current densities, 5 wt. % NaBH₄ (5 wt. % NaOH); (b) effect of boric acid (H₃BO₃) concentration, current density of template preparation, 80 mA cm⁻², 5 wt. % NaBH₄ (5 wt. % NaOH).

As seen in FIG. 7(i), H₂ generation rate was lowest when the template was prepared at a current density of 80 mA cm⁻²; at this current density, the voltage may not have been sufficient for ionization of borate and its incorporation in the deposit. H₂ generation was more or less the same with the templates prepared at higher current densities. The effect of H₃BO₃ concentration in the plating bath on H₂ generation efficiency is shown in FIG. 7(ii). The H₂ generation rate of the templates increased with increasing H₃BO₃ content in the plating bath up to 0.75 M, and the H₂ generation rate of the template prepared with 1.00 M H₃BO₃ was lower due to the unstable nature of the bath. Hence, 0.75 M H₃BO₃ could be considered as the optimum concentration for the deposition process in some embodiments of the invention.

### Calculation of Activation Energy of the Catalysts

H₂ generation increases linearly with temperature and drops suddenly after all of the NaBH₄ is hydrolyzed. Assuming zeroth order kinetics for CO₂B-catalyzed H₂ generation, the rate equation could be written as

$$k = {k}_{0} exp ( \frac{- E}{RT} )$$

where k is the reaction rate (mol min⁻¹g⁻¹), k₀ is the constant (mol min⁻¹g⁻¹), E is the activation energy, R is the universal gas constant, and T is the reaction temperature in degrees Kelvin.

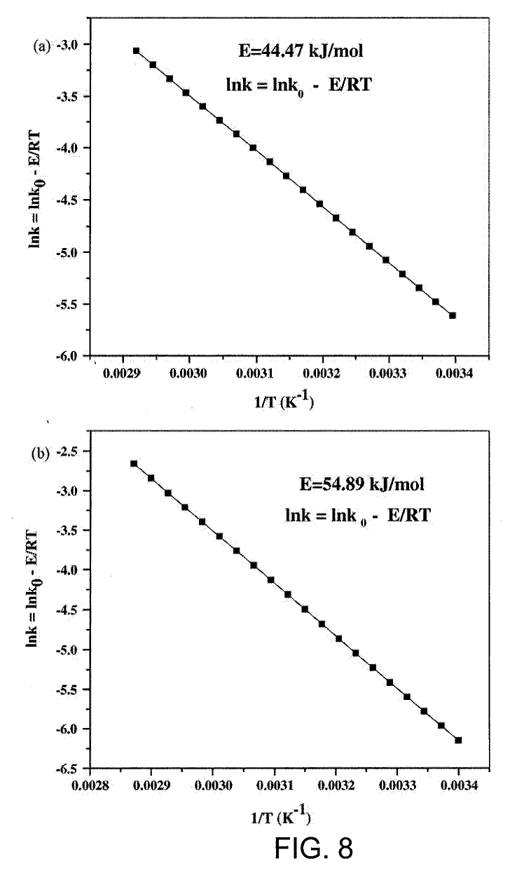

In FIG. 8(a) and FIG. 8(b), ln k is plotted against 1/T for H₂ generation by electroless plated and electroplated CoB/Ni-foam templates respectively. The activation energy from the slope was found to be 44.47 and 54.89 kJ mol⁻¹ for the CoB/Ni-foam templates prepared using electroless and electroplating methods, respectively. The activation energy values are close to the value of 45.64 kJ mol⁻¹ reported in the literature for a Co/activated carbon supported catalyst. The difference in the activation energy of the electroless, electroplated catalysts is due to the difference in their composition. The normalized B content in the electroless plated catalyst-coated template was in the range of 1.0-1.30 wt. %, whereas it was only 0.20-0.60 wt. % for the catalyst obtained by electroplating. This shows that the catalyst obtained by electroless plating will typically have more of CoB than that obtained by the electroplating method. Since CoB alloy is the active catalyst, the lesser percentage of CoB alloy in the electroplated catalyst is the probable reason for higher activation energy of this catalyst when compared with that obtained with electroless plating method. The nickel foam template used in this work had a density in the range of 300-600 g m⁻³. Since the density will be reduced on coating the foam template with the catalyst, an approximate density of 300 g m⁻³ was used to calculate the volumetric productivity of the catalyst-coated templates. From the H₂ generation rates plotted in FIGS. 4, 5 and 7, a volumetric productivity in the range of 0.48-1.12 and 0.24 mol L⁻¹ h⁻¹ was calculated for the electroless, electroplated CoB/Ni-foam catalyst-coated templates, respectively.

Potential applications for the catalyst-coated templates of this invention are numerous. For example, difficulties involved in setting up steam reformation units for H₂ production, purification, storage and transportation may be circumvented by adopting NaBH₄ based H₂ generators. This is an enabling technology for faster commercialization of PEMFCs. Pure H₂ may be prepared on demand, thereby enhancing the life of PEMFCs. The inexpensive Co—B based catalysts of the present invention may substantially reduce the overall cost of NaBH₄ based H₂ generation systems so that they may be easily adopted for common applications.

In one aspect, the invention may provide a source of pure H₂ for PEMFCs employed for residential power generation. Furthermore, due to the technical difficulties involved in the commercialization of other types of fuel cells, such as direct methanol fuel cells (DMFCs), NaBH₄ based H₂ generators along with PEMFCs may be useful as power sources for portable electronic devices such as cell phones, digital cameras, laptop computers, etc. This technology might also find application for automobile power generation in the future.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A catalyst-coated nickel template comprising
a) an open-cell nickel foam having within it pores defined by an internal nickel surface, the foam also having an external nickel surface not within the pores; and
b) a layer of catalyst comprising Co and B on at least a portion of the internal nickel surface and at least a portion of the external nickel surface.

2. The catalyst-coated nickel template of claim 1, wherein the open-cell nickel foam has a surface area in a range from 0.02 to 0.06 m²g⁻¹.

3. A method of making a catalyst-coated nickel template, comprising contacting a nickel template with a solution comprising a cobalt salt, a complexing agent, and a boron source selected from organoboranes and organoamine boranes under conditions sufficient to deposit boron and cobalt on a surface of the nickel template.

4. The method of claim 3, wherein the nickel template is in the form of a screen or perforated plate.

5. The method of claim 3, wherein the nickel template is an open-cell nickel foam.

6. The method of claim 5, wherein the open-cell nickel foam has a surface area in a range from 0.02 to 0.06 m²g⁻¹.

7. The method of claim 3, wherein the complexing agent comprises succinic acid, sodium succinate, potassium succinate, or a mixture of any of these.

8. The method of claim 3, wherein the complexing agent comprises citric acid, sodium citrate, potassium citrate, or a mixture of any of these.

9. The method of claim 3, wherein the boron source comprises an organoamine borane.

10. The method of claim 3, wherein the boron source comprises dimethylamine borane.

11. The method of claim 3, wherein the contacting is performed under electroless plating conditions.

12. A method of making hydrogen, comprising contacting a catalyst-coated nickel template according to claim 1 with a solution of NaBH₄.

13. A catalyst-coated nickel template prepared by the method of claim 3.

14. A method of making hydrogen, comprising contacting a catalyst-coated nickel template according to claim 13 with a solution of NaBH₄.

15. A method of generating H₂ at a predetermined rate, comprising:
a) providing one or more monolithic catalyst-coated nickel templates, each comprising a nickel template having on a surface thereof a catalyst coating comprising at least Co and B;
b) providing a solution of NaBH₄; and
c) causing a portion of the one or more monolithic catalyst-coated nickel templates to contact the NaBH₄ solution to a degree capable of generating the hydrogen at the predetermined rate.

16. The method of claim 15, wherein the one or more monolithic catalyst-coated nickel templates each comprises a nickel template having a surface area in a range of about 0.02 to 0.06 m²g⁻¹.

17. The method of claim 15, wherein the one or more monolithic catalyst-coated nickel templates each comprises an open-cell nickel foam.
